(19) United States
(12) Patent Application Publication
(10) Pub. No.: US 2026/0140486 A1
(43) Pub. Date: May 21, 2026

(54) COMPUTER-IMPLEMENTED METHOD FOR DESIGNING A STATE CONTROLLER, IN PARTICULAR FOR A VEHICLE, WITH STOCHASTIC OPTIMIZATION IN THE PRESENCE OF STATIC AND TIME-VARIANT UNCERTAINTIES

(71) Applicant: Robert Bosch GmbH, Stuttgart (DE)

(72) Inventors: Kevin Schmidt, Herrenberg (DE); Joachim Hoffmann, Fellbach (DE); Thomas Specker, Ditzingen (DE)

(21) Appl. No.: 19/389,690

(22) Filed: Nov. 14, 2025

(30) Foreign Application Priority Data
Nov. 15, 2024 (DE) 10 2024 211 000.0

(51) Int. Cl. G05B 13/04; G06F 17/11; G06F 17/17

(52) U.S. Cl. CPC G05B 13/042; G05B 13/047; G06F 17/11; G06F 17/17

(57) ABSTRACT

A computer-implemented method for designing a state controller with stochastic optimization. The method aims to solve the optimization problem in the presence of static and time-variant uncertainties by using the decomposition and optimization steps to determine the component of the state controller feedback matrix.

This application claims priority under 35 U.S.C. § 119 to application no. DE 10 2024 211 000.0, filed on Nov. 15, 2024 in Germany, the disclosure of which is incorporated herein by reference in its entirety.

The present disclosure relates to techniques for designing a state controller with stochastic optimization. Related aspects relate to a computer program, a computer system, a computer readable medium or signal, and a state controller.

### BACKGROUND

Highly automated or autonomous systems are an increasingly important area of focus in the robotics and automotive industries, for example. Control systems in particular are of increasing importance in the operation of autonomous or highly automated systems. Some problems arise in distributed systems in which, for example, the control algorithm is executed physically separately from the system to be controlled, for example, by cloud computing or edge computing, thereby giving rise to time delays during data transfer.

Due to varying physical conditions affecting signal transmission, or varying channel utilization in vehicle-to-vehicle (V2V) communication, there may be time delays and additionally varying sampling times that are non-deterministic and thus uncertain. The time delays can be classified as static uncertainties, whereas the varying sampling times can be classified as time-dependent uncertainties (so-called jitter). For example, networked adaptive speed control, group start, or cooperative merging of traffic lanes can be situations where channel utilization is unusually high relative to other situations. For example, non-deterministic delays and/or varying sampling times may result in the feedback circuit, in bus communication when distributed E/E architectures are involved in vehicle control functions, and/or in signal processing and transmission in sensor systems. In control systems, such as longitudinal guidance of a vehicle, the non-deterministic time delay and the varying sampling times may affect control success. Moreover, other time-dependent uncertainties such as, for example, a time-variant external wind force while driving a vehicle, and/or static uncertainties such as load-dependent yaw and mass of the vehicle, distances of vehicle center of gravity to the axles, and roadway friction (with impact on stiffness) may adversely affect control success if these effects are not sufficiently considered. In the context of product virtualization, however, it is desired and necessary to take into account such stochastic effects simultaneously and simulatively even in the early-design phase.

Some prior art methods take into account some of the time-dependent uncertainties set forth above. Other prior art methods consider some of the above static uncertainties using methods that are in some cases not compatible with the methods for estimating the time-dependent uncertainties. Solving an optimization problem directly (without further simplifications/approximations) for a controller while simultaneously taking into account the static and time-dependent uncertainties with the conventionally extensive and computationally intensive stochastic methods, such as UQ methods (Standard Monte-Carlo, Latin Hypercube Sampling), is not computationally practicable and is economically unsuitable in some cases. On the other hand, however, it is not sufficient to quantify the contributions of these uncertainties in the control loop separately for each type of uncertainty (i.e., each uncertainty individually) using the corresponding techniques and so, for example, to design a feedback matrix of a controller since the uncertainties in their entirety (and in a complex, mostly non-linear manner) act in the control loop and influence its performance.

Thus, there is a need to develop new techniques for designing a state controller that can simultaneously quantify static and time-dependent uncertainties.

### SUMMARY

A first general aspect of the present disclosure relates to a computer-implemented method for designing a state controller with stochastic optimization, wherein the method comprises receiving a dynamic model for describing a system to be controlled, wherein the dynamic model is represented by a predefined function. The predefined function of the first aspect includes the following time-dependent arguments: a state vector comprising one or more state variables; an input vector comprising one or more input variables connected to the state vector by a feedback matrix describing the state controller, and a stochastic parameter vector having at least one component describing a time-dependent uncertainty parameter. Furthermore, the predefined function has a non-linear dependency with respect to the stochastic parameter vector and also includes a time-independent argument given by a static parameter vector comprising at least one component that is a static uncertainty parameter. Furthermore, the method comprises forming a discrete-time representation of the dynamic model for describing the system to be controlled by a time discretization of the predefined function. Furthermore, the method comprises decomposing the stochastic parameter vector into one or more deterministic modes, wherein each mode is associated with a respective eigenvalue, wherein the decomposed stochastic parameter vector is determined based on a random vector comprising one or more random variables as components; In the next step, the method comprises approximating the predefined function to resolve the non-linear dependence with respect to the stochastic parameter vector. Furthermore, the method comprises solving an optimization problem to determine the component of the feedback matrix, wherein the optimization problem comprises a cost function, wherein the cost function is calculated based on one or more expected values and one or more variances of the one or more state variables of the state vector and/or the one or more input variables of the input vector.

A second general aspect of the present disclosure concerns a computer program adapted to perform the computer-implemented method of designing a state controller with stochastic optimization according to the first general aspect.

A third general aspect of the present disclosure concerns a computer system adapted to perform the computer-implemented method of designing a state controller with stochastic optimization according to the first aspect and/or the computer program according to the second aspect.

A fourth general aspect of the present disclosure relates to a computer-readable medium or signal, which stores and/or contains the computer program according to the second general aspect.

A fifth general aspect of the present disclosure relates to a state controller adapted to control a system, in particular an autonomous and/or automated driving system, wherein the state controller has been optimized according to the computer-implemented method of designing a state controller with stochastic optimization according to the first aspect.

The techniques of the first to fifth general aspects can have one or more of the following advantages.

Firstly, the techniques of the present disclosure are to provide a method for designing a state controller with stochastic optimization. In particular, the proposed methods may allow that a small number of simulation steps (in some cases even only one simulation) is sufficient, to characterize/quantify the influence of time-dependent uncertainties along with static uncertainties on a control system, which may represent a significant gain in efficiency (in terms of computational time and hardware resources) versus a high number of simulations using inefficient prior art UQ methods. This may lead to savings on the one hand in terms of runtime and on the other hand in terms of the computing resources necessary for the simulation.

Secondly, solving an optimization problem according to the first aspect (e.g., with the aim of determining a feedback matrix) may be obtained prior to design of the state controller (e.g., the optimization problem may be solved on a separate computer system), which may reduce the computing power required in designing the state controller. By way of the discrete-time representation of the dynamic model taking into account the time-dependent uncertainty parameter based on the stochastic process, a better representation of reality can be created, in particular with distributed control systems, and thus the design of the state controller can be improved.

Thirdly, the techniques of the present disclosure may map the uncertain time-dependent effects along with static effects in a data transmission channel and/or account for those effects when sampling transmitted signals. Moreover, the uncertainty quantification may be performed using the resource-saving calculation at runtime (“online”).

Fourthly, the present techniques provide the ability to analyze existing controllers to evaluate their robustness and/or compare their performance to a configured state controller optimized with the present techniques.

Some terms are used in the present disclosure in the following manner:
A “state controller” may comprise an algorithm, i.e., a calculation specification, that returns a full or partial state variable (i.e., the internal state of the control section) for an input variable. A state controller may include parameters that can weight the state variable. In examples, a state controller may be executed on a computer system. In examples, a state controller may be executed in a controller of a vehicle, cloud, or edge. For example, a state controller may include or be part of a hardware module having inputs and outputs. In the examples, a state controller may be a controller, a part of the controller, or the controller itself.

In one example, the “system to be controlled” in the present disclosure may be designed to be arranged within a vehicle and/or designed to control a vehicle function (in particular, to control a travel function). For example, the vehicle function may be an autonomous and/or assisted driving function. In some examples, the state controller may be configured for execution on a computer system of a vehicle (e.g., an autonomous, highly automated, or assisted driving vehicle). For example, the computer system may be implemented locally in the vehicle or (at least in part) may be implemented in a backend communicatively connected to the vehicle. For example, the computer system may comprise a controller on which the state controller may be executed. In some examples, the vehicle may comprise a computer system having a communication interface that enables communication with a backend. For example, the state controller may be executed in this backend. In examples, the time uncertainties may arise from the data transfer between the system to be controlled and the computer system executing the state controller. In one example, the “system to be controlled” may be a system for lateral guidance and/or longitudinal guidance of the vehicle. In examples, “a state vector” may be based on speed information or distance information. In examples, the state vector may comprise a relative speed and/or a distance between a first vehicle, a second vehicle, a human, and/or a stationary object. In one example, “the state vector” may comprise components that are based on at least one of a steering angle, an orientation angle, a yaw rate, a slip angle, and/or a lateral error. In examples, the state vector may comprise information from a network, such as movement and/or direction information from other vehicles. In examples, this information may be provided by vehicle-to-vehicle (V2V) communication or by a backend (V2X) communication. In one example, an “input vector” may comprise a steering angle, a steering speed or targets for acceleration and/or braking operations. In examples, the “system to be controlled” may be designed to be arranged in an engine controller or power unit and/or used to regulate an engine-related function (in particular, for engine control). In examples, the “system to be controlled” may be designed to be arranged in a drive control of an electric machine. For example, “the state vector” may contain components based on at least one of a control signal, an operating mode, or a power setting of the electric machine.

In the context of the present disclosure, it is also conceivable that “the system to be controlled” may be arranged in a robot and/or configured to control a robot function (in particular for controlling a travel function of a robot and/or a movement function of a robot, e.g., of robot arms). For example, the “system to be controlled” may be a system for lateral guidance and/or longitudinal guidance of the robot. In some examples, the state controller may be executed on a computer system of a robot. For example, the computer system may be implemented locally in the robot or (at least in part) may be implemented in a backend communicatively connected with the robot. In some examples, the state controller may be executed in a backend. In examples, “the state vector” may be based on speed information or distance information. In examples, the “state vector” may comprise a relative speed and/or a distance between a first robot, a human, another mobile device, and/or a stationary object. In one example, the state vector may comprise variables that are based at least on one of a steering angle, an orientation angle, a yaw rate, a slip angle, and/or a lateral error. In examples, the state vector may comprise information from a network, such as movement and/or direction information from other robots, mobile devices, and/or humans. In examples, this information may be provided via direct communication or by a backend. In one example, an “input vector” may comprise a steering angle, a steering speed or targets for acceleration and/or braking operations.

Moreover, “the system to be controlled” may be directed for control of distributed systems, for example for longitudinal vehicle guidance of multiple vehicles (“platooning” is an example). In addition to longitudinal vehicle guidance, “the system to be controlled” may provide control of distributed systems, such as automated guided vehicles (AGV). This control may be adapted, for example, to drive and/or coordinate driverless transport vehicles in a restricted area, in particular, in a logistics center and/or production plant, using a local network (e.g., local edge, 5G network, 6G network, etc.). As another example, the distributed systems may comprise robot arms in a local area network, e.g., in a manufacturing system. The control algorithms of at least these robot arms may be at least partially outsourced (i.e., at least partially decentralized).

The “uncertainty parameter” may be “a time-dependent uncertainty parameter” or “a static uncertainty parameter”, which is of a non-deterministic (e.g., stochastic) nature, and occur in the feedback of the control loop of a state controller and thus affect its performance. For example, “a static uncertainty parameter” may mean that it is constant for a particular device, such as a vehicle or a robot (and/or environment in which the device is operated) over time and therefore, it acts as a constant scalar in “a system to be controlled” but if varies from device to device (and/or environment to environment in which the device is operated). Examples of this are a time delay between computing units of the distributed systems, between a state controller and an actuator of a vehicle, between a sensor of the vehicle and the state controller (or any combination thereof). Further examples include the road friction on which a vehicle is traveling, the location of the center of gravity of the vehicle, the load-dependent yaw and mass of the vehicle, and the distances of the center of gravity to the axles. In some cases, “a static uncertainty parameter” may be described using a predefined (in other words, known) statistical distribution.

Accordingly, “a time-dependent uncertainty parameter” may be understood to mean any uncertainty parameter that is time-variant, i.e., it fluctuates over time and is therefore to be considered a time-dependent scaler in “a system to be controlled”. An example of this is jitter, i.e., an accuracy variation in the transmission clock of computing units of the distributed systems, such as a state controller and an actuator of a vehicle, a sensor of the vehicle, and the state controller (or any combination thereof). Another example is a time-variant external wind force while driving a vehicle. In some cases, “a time-dependent uncertainty parameter” may be described by a predefined (in other words, known) stochastic process (in other words, modeled).

A “dynamic model” for the description “of a system to be controlled” may be a model that quantitatively describes one or more functions of a device (e.g., one or more vehicle functions of a vehicle or one or more robot functions of a robot). This quantitative description may include, for example, a temporal and/or spatial dependence of one or more “state variables” and/or one or more “input variables” representing the behavior of this function or these functions of the device. Moreover, the “dynamic model” may comprise parameters (e.g., uncertainty parameters defined above), upon which the state variables and/or input variables may be dependent. Alternatively or additionally, “dynamic model” may comprise parameters that may have an impact on the dynamic change in the state variables and/or input variables. The “dynamic model” can be a comprehensive (in the sense of equations, e.g., a system of coupled equations (such as differential equations) for the state variables, input variables and/or uncertainty parameters used for describing the behavior of a function of a device) and computationally complex simulation model. In this context, within the scope of the present disclosure, models may be derived by simplification of the dynamic model (in other words, these models will approximate the dynamic model) that are less computationally intensive than the (original) dynamic model. These simplified models are hereinafter referred to as “surrogate models” in some cases.

A “vehicle” may be any device that transports passengers and/or freight. A vehicle may be a motor vehicle (for example, a car or a truck) but also a rail vehicle. A vehicle may also be a motorized two or three wheel vehicle. However, floating and flying devices may also be vehicles. Vehicles may be at least partially autonomously operating or assisted.

### BRIEF DESCRIPTION OF THE FIGURES

FIG. 1a is a flow chart depicting an example of one embodiment for designing a stochastic optimization state controller according to the first aspect of the disclosure. FIG. 1b through 1d are flow charts showing further possible method steps according to the first aspect.

FIG. 2 schematically illustrates an exemplary control loop according to one or more embodiments of the present disclosure.

FIG. 3a to FIG. 3c illustrate exemplary results of returning a moving car to a traffic lane by way of a straight-line driving maneuver, which was achieved using the state controller with stochastic optimization according to the present disclosure, in comparison to the results obtained using the prior art.

### DETAILED DESCRIPTION

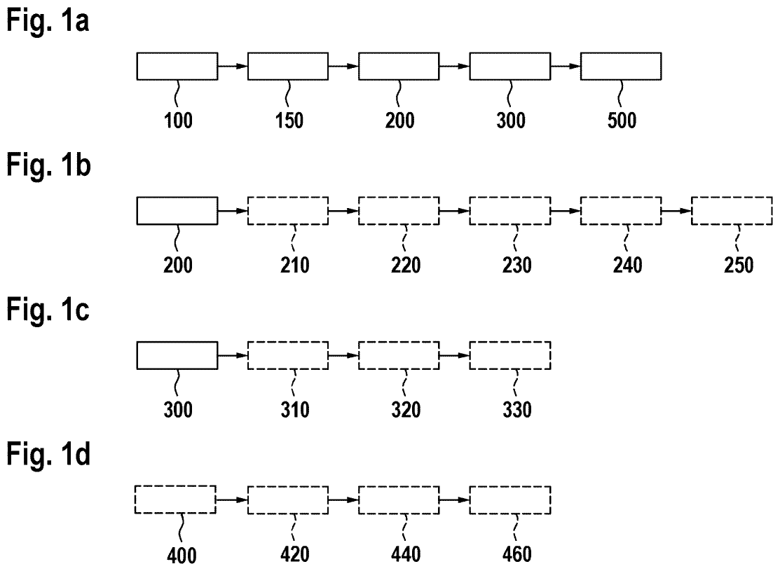

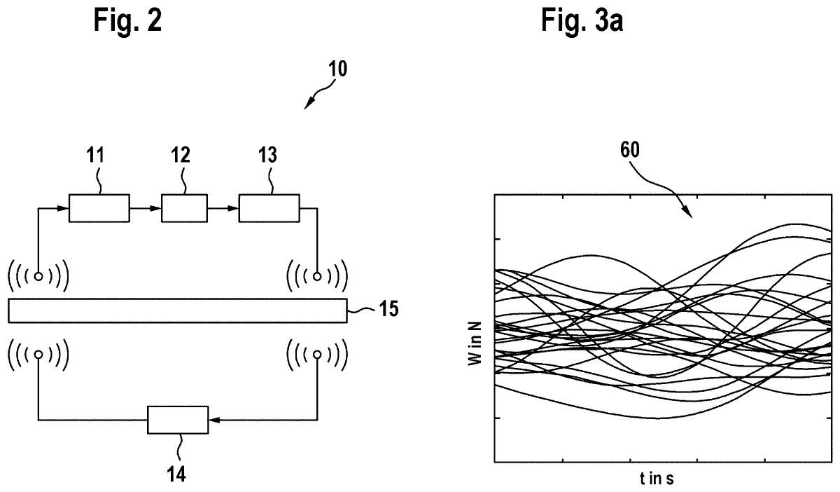

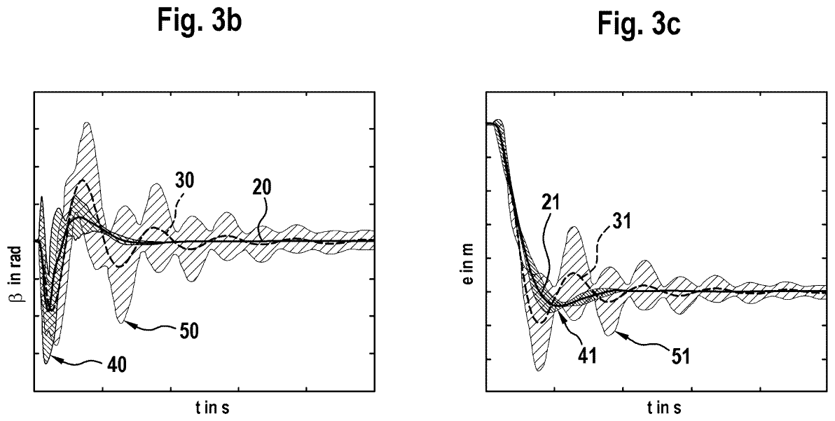

Firstly, techniques for designing a state controller with stochastic optimization are described using FIGS. 1a to 1d and FIG. 2. Subsequently, exemplary results of the optimization method of the present techniques are compared to conventional methods using FIGS. 3a to 3c.

As outlined in FIGS. 1a to 1d, a first general aspect relates to a computer-implemented method of designing a state controller with stochastic optimization. The method steps of the below description are shown in the boxes drawn by solid lines in FIG. 1a to 1d, while the method steps of some of the below description are shown in the boxes illustrated with dashed lines.

The first step of the method comprises receiving 100 a (e.g., continuous) dynamic model (in the above-defined sense) for describing a system 12 to be controlled (see above definitions), wherein the dynamic model is represented by a predefined function f(zₖ, p, wₖ, uₖ). (k represents a point in time; for “discretization” see the discussions below.) The predefined function of the first aspect includes the following time-dependent arguments: a state vector zₖ comprising one or more state variables (e.g., two or more, three or more, or four or more state variables); an input vector uₖ comprising one or more input variables and associated with the state vector zₖ via a feedback matrix K describing the state controller. In some cases, the input vector uₖ may comprise two or more, three or more, or four or more input variables. In one example, a control law may describe the influence of the state vector zₖ using the feedback matrix K to input the result of this influence into the system to be controlled as an input vector uₖ. In one example, the control law can be expressed by way of the equation

$${u}_{k}^{i} = {K}_{i j} {z}_{k}^{j}$$

from which the input vector uₖ is formed (i and here j refers to the components of the input or state vector). In one example, it is possible to account for immeasurable state variables

$$( {z}_{k}^{j} )$$

that are associated with disappearing feedback matrix components Kᵢⱼ=0 for all i≥1. i may refer to the row index and j to the column index of the feedback matrix. This is an example of a limited definition set K∈ [symbol] .

The system 12 to be controlled (e.g., a system for transverse guidance and/or longitudinal guidance of a vehicle or another system as discussed above) is shown by way of example in FIG. 2. In some cases, the state controller 14 may output the input vector uₖ to one or more actuators. In examples, the input vector uₖ may be output to the one or more actuators via a network 15. An example of such an actuator 11 is shown in FIG. 2. Moreover, the state controller 14 may receive the state vector zₖ from one or more sensors and/or one or more state estimators of system 12 to be controlled (e.g., via network 15). An example of such a sensor 13 is shown in FIG. 2. In examples, network 15 may be a wired and/or wireless network. In examples, the network may comprise a LAN (Local Area Network), a WLAN (Wireless Local Area Network), CAN (Controller Area Network), an IoT network, a 5G network, or a multi-access edge computing network. In examples, the state controller 14 may be run in a cloud or edge (other examples described above).

Moreover, the predefined function of the first aspect as a time-dependent argument includes a stochastic parameter vector wₖ having at least one component comprising a time-dependent uncertainty parameter describing a stochastic process. In some cases, the stochastic parameter vector wₖ may comprise one or more, two or more, three or more, or four or more components. In examples, each of these components may comprise a corresponding time-dependent uncertainty parameter describing a respective stochastic process. Moreover, the predefined function has a non-linear dependency (e.g., a square, cubic, exponential, or other non-linear dependency) with respect to the stochastic parameter vector. In some cases, the square dependency may be written as follows:

$$∼ {w}_{k}^{j} {w}_{k}^{l} ,$$

where k designates a time point and j (l) a component of the stochastic parameter vector wₖ. In addition, the predefined function includes a time-independent argument given by a static parameter vector p comprising at least one component containing a static uncertainty parameter. In some cases, the static uncertainty parameter may be described using a predefined statistical distribution (as already discussed above). In examples, the static parameter vector p may comprise one or more, two or more, three or more, or four or more components. In some cases, each of these components may comprise a corresponding static uncertainty parameter described by a corresponding predefined statistical distribution.

The next step of the method includes forming 150 a discrete-time representation of the dynamic model for describing the system to be controlled by time discretization of the predefined function. Forming the discrete-time representation of the dynamic model for describing the system to be controlled may comprise receiving an initial state vector z₀ associated with an initial time point to, and determining a next time step for the state vector zₖ₊₁ by calculating the predefined function f(zₖ, p, wₖ, uₖ) at a previous time step, starting from the initial time point. The integers k≥0 correspond to the discrete time points. The discrete-time state-space model may be described by the equation

$$\begin{matrix}\begin{matrix}{z}_{k + 1} = f ( {z}_{k} , p , {w}_{k} , {u}_{k} ) , & k ∈ \{ 0 , … {k}_{f} \}\end{matrix} \\ \begin{matrix}{u}_{k}^{i} = {K}_{ij} {z}_{k}^{j} , & K ∈ 𝕂\end{matrix}\end{matrix}$$

in one example. (As described above i and j are the components of the input or state vector and the line or column index of the feedback matrix K). For the majority of times tₖ, the following may apply: tₖ=t₀+(k−1)h, k=0, 1, 2, . . . , k_{f}, where a sampling time h may remain the same or vary from time point to time point. In some cases, the sampling time h may vary due to one or more time-dependent uncertainties (e.g. jitter). Such an uncertain sampling time may in some cases be described by one or more components of the stochastic parameter vector wₖ in the predefined function accordingly. In examples, the start time t₀ may be fixed at any one of the first (integer) multiples k of the sampling time h (in other words, the determination of the start time is not limited).

Next, the present techniques include decomposing 200 the stochastic parameter vector wₖ into one or more deterministic modes g_{i,k} (e.g., into two or more, five or more, ten or more, fifty or more deterministic modes), wherein each mode is associated with a particular eigenvalue λⱼ. Here, the term “deterministic mode” may mean that it is not stochastic in nature. The decomposed stochastic parameter vector wₖ is determined based on a random vector comprising one or more random variables ζⱼ as components. (In the non-limiting expression for the deterministic modes g_{j,k}, the index j stands for the numbering and the index k denotes the time points.) Moreover, the decomposition of the stochastic parameter vector wₖ into the one or more deterministic modes g_{i,k} may include receiving 210 a predefined correlation function C(t, t′) quantifying a temporal correlation of the stochastic process between a first time tₖ point and a second time point tₗ, which are different from each other and are within a predefined time interval T. For example, this temporal correlation of the stochastic process may be given by the temporal correlation between the stochastic parameter vector at the first and second time points (e.g., wₖ and wₗ). In one example, the correlation function C(t, t′) may be determined using measurement data from the stochastic process. In another example, the correlation function C(t, t′) may be determined based on the regression of the stochastic process.

To this end, the “decomposition” method step may comprise solving 220 an eigenvalue problem using the predefined correlation function to determine one or more eigenvalues λⱼ and the one or more deterministic modes g_{j,k}. In one example, the eigenvalue problem may be written as follows:

$${λ}_{j} {g}_{j} ( t ) = {\int }_{0}^{T} C ( t , {t}^{′} ) {g}_{j} ( {t}^{′} ) d {t}^{′} ⇒ C {g}_{j , ( \cdot )} = {λ}_{j} {g}_{j ,}$$

The index j stands for numbering of the modes gⱼ or eigenvalues λⱼ. This exemplary equation is written in continuous form for the time and can be converted into a discrete form of g_{j,k} with known methods.

In the techniques of the present disclosure, decomposing the stochastic parameter vector into the one or more deterministic modes may further comprise calculating 230 of the one or more random static variables ζⱼ of the random vector distributed according to a predefined statistical distribution. Brownian motion (e.g., given by ζⱼ˜ [symbol] (0,1)) and the Gaussian process (e.g., given by ζⱼ˜ [symbol] (0,1) are two non-limiting examples of statistical distributions that can be used to generate the random variables ζⱼ. To this end, the “decomposition” method step may comprise calculating 240 a sum consisting of one or more terms, wherein each term of this sum is a product of a deterministic mode and a factor calculated based on the eigenvalue to which this deterministic mode belongs, and a particular random variable of the random vector. Subsequently, the “decomposition” method step may comprise determining 250 the decomposed stochastic parameter vector (e.g., at the predefined time interval T) based on the calculated sum. In some cases, a number L of the one or more deterministic modes g_{i,k} may be selected such that the decomposed stochastic parameter vector wₖ satisfies a predefined criterion. For example, the predefined criterion may comprise one or more modes not associated with the one or more deterministic modes providing a contribution when added to the decomposed stochastic parameter vector wₖ that is less than a predefined threshold.

In the present techniques, the “decomposition 200” method step of the stochastic parameter vector wₖ into the one or more deterministic modes g_{i,k} may be based on a Karhunen-Loeve expansion (see, e.g., Betz et al, “Numerical methods for the discretization of random fields by way of the Karhunen-Loeve expansion”, Computer Methods in Applied Mechanics and Engineering 271 (2014): 109-129). In examples, the following may apply to the decomposition:

$${w}_{k} = \overline{w} + {\sum }_{j = 1}^{L} \sqrt{{λ}_{j}} {ζ}_{j} {g}_{j , k} .$$

In this equation, w̅ is a mean stochastic parameter vector, e.g., averaged within a predefined time interval T, and the other terms are already defined above. In some cases, the above equation may be shortened as follows: wₖ=Λζ^{T}gₖ.
The next step of the method includes approximating 300 the predefined function to resolve the non-linear dependence with respect to the stochastic parameter vector wₖ. In one example, this elimination of the non-linear dependence may mean that in a Taylor expansion of the predefined function, only terms that are independent of the stochastic parameter vector are maintained and/or terms that contain a linear contribution with respect to the stochastic parameter vector, while terms that contain a higher order contribution with respect to the stochastic parameter vector are neglected by the Taylor expansion. In another example, the elimination of the non-linear dependence may mean that a non-linear term with respect to stochastic parameter vector is approximated by another stochastic parameter vector.
In the techniques of the present disclosure, approximating the predefined function f(zₖ, p, wₖ, uₖ) may further comprise determining 310 a first contribution calculated by calculating the predefined function for a mean stochastic parameter vector w̅, wherein the mean stochastic parameter vector is averaged within a predefined time interval. To this end, the “approximation” method step may comprise determining 320 a second contribution comprising the decomposed stochastic parameter vector and a function associated with the predefined function calculated for the mean stochastic parameter vector w. Subsequently, the “approximation” method step may comprise approximating 330 the predefined function based on the first and the second contributions. In one example, the approximated predefined function may be written as follows (see also the example expression above for the decomposed stochastic parameter vector wₖ):

$${z}_{k + 1} = f ( {z}_{k} , p , {w}_{k} , {u}_{k} ) \approx f ( {z}_{k} , p , \overline{w} , {u}_{k} ) + {d}_{w} f ( {z}_{k} , p , \overline{w} , {u}_{k} ) {w}_{k} = f ( {z}_{k} , p , \overline{w} , {u}_{k} ) + {d}_{w} f ( {z}_{k} , p , \overline{w} , {u}_{k} ) Λ {ζ}^{T} {g}_{k} .$$

In some cases, if the predefined function is a differentiable function with respect to the stochastic parameter vector, the function associated with the predefined function may be based on a Jacobian matrix of the predefined function calculated in the mean stochastic parameter vector. In the examples, the function associated with the predefined function may assume the following expression: d_{w}f=∂f/∂w|_{w=w̅}. Alternatively, the function associated with the predefined function may be based on a difference quotient with respect to the predefined function calculated in the mean stochastic parameter vector as an expansion point, if the predefined function is not a differentiable function with respect to the stochastic parameter vector. A distance used in the difference quotient may be selected based on a variance of the stochastic process. For example, the distance may be defined as follows: δ=\sqrt{V(wₖ)}. (If the stochastic parameter vector wₖ comprises more than one component, then a particular variance may be defined for each stochastic process associated with the corresponding component of wₖ, see also the discussions above.) In examples, the difference quotient may be a forward difference quotient, a central difference quotient, or another difference quotient derived using higher order Taylor series expansions. In one case, the function associated with the predefined function may be given by the following expression (written for simplicity for the one-dimensional case):

$${d}_{w} f ( {z}_{k} , p , \overline{w} , {u}_{k} ) = \frac{f ( {z}_{k} , p , \overline{w} + δ , {u}_{k} ) - f ( {z}_{k} , p , \overline{w} - δ , {u}_{k} )}{2 δ} .$$

In some cases, the approximated function may be determined using Stirling's interpolation (see J. F. Steffensen, Interpolation. Bailliere, Tindall & Cox, 1927).

Accordingly, in the context of the present disclosure, the approximated function with respect to the decomposed stochastic parameter vector may take on a multiplicative form with respect to the stochastic parameter vector. Alternatively or additionally, the approximated function with respect to the decomposed stochastic parameter vector may take on an additive form with respect to the stochastic parameter vector.

The multiplicative form with respect to the stochastic parameter vector means that this approximated function comprises one or more multiplicative terms that are proportional to the product of the state vector and the one or more deterministic modes. Alternatively or additionally, the multiplicative form with respect to the stochastic parameter vector means that this approximated function comprises one or more multiplicative terms that are proportional to the product of the input vector and the one or more deterministic modes. In some cases, a corresponding proportionality coefficient may be a matrix that depends on an uncertainty vector that comprises the following vectors: i) the static parameter vector, ii) the random vector, and iii) a mean stochastic parameter vector averaged within a predefined time interval. In examples, the uncertainty vector can be written as follows: θ=[p^{T}, ζ^{T}, w̅^{T}]^{T}. (The superscript T here stands for the transposition.) In some cases, the multiplicative form of the approximated function with respect to the decomposed stochastic parameter vector may be written as follows:

$${z}_{k + 1} = {g}_{k}^{T} \tilde{A} ( θ ) {z}_{k} + {g}_{k}^{T} \tilde{B} ( θ ) {u}_{k} .$$

Ã(θ) and \tilde{B}(θ) are the corresponding matrices.
The additive form discussed above with respect to the stochastic parameter vector may mean that this approximated function comprises one or more additive terms that are proportional to the one or more deterministic modes. In one example, a corresponding proportionality coefficient may be a matrix that is dependent on the uncertainty vector (e.g., θ defined above). In some cases, the additive form of the approximated function with respect to the decomposed stochastic parameter vector may be written as follows:

$${z}_{k + 1} = E ( θ ) {g}_{k} .$$

E(θ) is a corresponding matrix. In some cases, the approximated function with respect to the decomposed stochastic parameter vector may take on a multiplicative and additive form with respect to the stochastic parameter vector. In this case, the approximated function may be written as follows:

$${z}_{k + 1} = {g}_{k}^{T} \tilde{A} ( θ ) {z}_{k} + {g}_{k}^{T} \tilde{B} ( θ ) {u}_{k} + E ( θ ) {g}_{k} .$$

In some cases, the approximated function may also contain terms that are proportional to the state vector and/or the input vector. For example, the approximated function may include the one or more multiplicative and/or additive terms and the terms that are proportional to the state vector and/or the input vector. In this case, the approximated function (in other words: the discrete-time representation of the dynamic model) may be written in some examples as follows:

$${z}_{k + 1} = [ \overline{A} ( θ ) + {g}_{k}^{T} \tilde{A} ( θ ) ] {z}_{k} + [ \overline{B} ( θ ) + {g}_{k}^{T} \tilde{B} ( θ ) ] {u}_{k} + E ( θ ) {g}_{k} .$$

Ā(θ) and B̅(θ) are the corresponding matrices.

Finally, the present techniques include solving 500 an optimization problem to determine the component of the feedback matrix K. The optimization problem comprises a cost function J calculated based on one or more expected values E(zₖ) and one or more variances V(zₖ) of the one or more state variables of the state vector zₖ. Alternatively or additionally, the cost function J is calculated based on one or more expected values E(uₖ) and one or more variances V(uₖ) of the one or more input variables of the input vector uₖ. Moreover, solving the optimization problem may further comprise determining 510 the one or more expected values and the one or more variances of the one or more state variables of the state vector zₖ. Alternatively or additionally, solving the optimization problem may comprise determining the one or more expected values and the one or more variances of the one or more input variables of the input vector uₖ. The cost function J can be formed by an expected value contribution J_{E}(E(zₖ); E(uₖ)) and a variance contribution Jᵥ(V(zₖ); V(uₖ)). For example, the expected value contribution may be formed by a first contribution corresponding to the one or more expected values of the one or more state variables of the state vector zₖ. Alternatively or additionally, the expected value contribution may be formed by a second contribution corresponding to the one or more expected values of the one or more input variables of the input vector uₖ. The variance contribution can be formed by a third contribution corresponding to the one or more variances of the one or more state variables of the state vector zₖ. Alternatively or additionally, the variance contribution may be formed by a fourth contribution corresponding to the one or more variances of the one or more input variables of the input vector uₖ.

In the present techniques, the optimization problem may include minimizing the cost function J with respect to the components of the feedback matrix K. In one example, the cost function J may be expressed by the equation J(z,u)=J_{E}(E(zₖ); E(uₖ))+Jᵥ(V(zₖ); V(uₖ)). For example, an associated optimization problem may then be formulated as follows:

$${min}_{K} J ( z , u ) = {J}_{E} ( E ( {z}_{k} ) ; E ( {u}_{k} ) ) + {J}_{V} ( V ( {z}_{k} ) ; V ( {u}_{k} ) )$$

$${z}_{k + 1} = f ( {z}_{k} , p , {w}_{k} , {u}_{k} ) , k ∈ \{ 0 , … {k}_{f} \}$$

$${u}_{k}^{i} = {K}_{i j} {z}_{k}^{j} , K ∈ 𝕂 .$$

In the present disclosure, solving the optimization problem may further comprise weighting the first contribution using a first expected value weighting matrix Q_{E} and weighting the second contribution using a second expected value weighting matrix R_{E}. Moreover, solving the optimization problem may further comprise weighting the third contribution using a first variance weighting matrix Q_{V} and weighting the fourth contribution using a second variance weighting matrix R_{V}. In some cases (e.g., when the feedback matrix K describes a linear-quadratic regulator), the expected value contribution J_{E}(E(zₖ); E(uₖ)) and the variance contribution J_{V}(V(zₖ); V(uₖ)) may be written as follows:

$${J}_{E} = {\sum }_{k = 0}^{{k}_{f}} E ( {z}_{k}^{T} ) {Q}_{E} E ( {z}_{k} ) + E ( {u}_{k}^{T} ) {R}_{E} E ( {u}_{k} ) , {J}_{V} = {\sum }_{k = 0}^{{k}_{f}} V ( {z}_{k}^{T} ) {Q}_{V} V ( {z}_{k} ) + V ( {u}_{k}^{T} ) {R}_{V} V ( {u}_{k} ) .$$

One or more expected value and/or variance matrices Q_{E}, R_{E}, Q_{V} or R_{V} may be positive semidefinite matrices.

In some cases of the present techniques, the first expected value weighting matrix Q_{E} and the first variance weighting matrix Q_{V} may be dependent on one another. For example, the first expected value weighting matrix Q_{E} and the first variance weighting matrix Q_{V} may be provided by a (identical) matrix Q̅ that is weighted with corresponding weighting factors. In one case, the first expected value weighting matrix Q_{E} and the first variance weighting matrix Q_{V} may be written, for example, as follows: Q_{E}=ω₁Q̅, Q_{V}=(1−ω₁)Q̅, where ω₁ is a first scalar parameter, 0<ω₁≤1. Moreover, in some cases, the second expected value weighting matrix R_{E} and the second variance weighting matrix R_{V} may be dependent on one another. For example, the second expected value weighting matrix R_{E} and the second variance weighting matrix R_{V} may be provided by a (identical) matrix R̅ that is weighted with corresponding weighting factors. In one case, the second value expected weighting matrix R_{E} and the second variance weighting matrix R_{V} may be written as follows: R_{E}=ω₂R̅, R_{V}=(1−ω₂)R̅, where ω₂ is a second scalar parameter, 0<ω₂≤1. In one case, the first scalar parameter is equal to the second scalar parameter (ω₁=ω₂). In the other case, the first scalar parameter is different from the second scalar parameter (ω₁≠ω₂).

In the context of the present disclosure, it is conceivable that the optimization problem corresponds to a target criterion with respect to the state vector zₖ and/or the input vector uₖ. For example, the target criterion may comprise the one or more state variables of the state vector zₖ assuming one or more corresponding predefined (in other words: desired) state variable values

$${z}_{k}^{d e s} .$$

The one or more corresponding predefined state variable values may be null

$$( {z}_{k}^{d e s} = 0 )$$

or take on other values. Alternatively or additionally, the target criterion may comprise the one or more input variables of the input vector uₖ assuming one or more corresponding predefined (in other words: desired) input variable values

$${u}_{k}^{d e s} .$$

The one or more corresponding predefined input variable values may be null

$$( {u}_{k}^{d e s} = 0 )$$

or take on other values.
In one example, solving 500 an optimization problem using a global search method, a simplex method, or a gradient method (see, e.g., Papageōrgiu, M.: Optimization. Static, dynamic, stochastic methods for application. Berlin: Springer 2012). In the event, for example, that a gradient method is performed, the necessary initial values (or initial value) of the feedback matrix Kᵢₙᵢ may be determined, for example, by a state controller without consideration of uncertainties, an expert opinion, or a global search. In an example in which the optimization problem is represented as minimizing the cost function, the computer-implemented method may be performed until the cost function assumes a predefined minimum value (within a predefined numerical accuracy) and/or until a predefined termination criterion is achieved.
In the context of the present techniques, it is conceivable that forming the discrete-time representation of the dynamic model for describing the system to be controlled may further comprise generating a number of samples (sampling) i) for the static parameter vector, ii) for the random vector, and iii) for a mean stochastic parameter vector averaged within a predefined time interval. In examples, the number of samples may be generated for the uncertainty vector θ=[p^{T}, ζ^{T}, w̅^{T}]^{T} mentioned above. Each sampling of the mean stochastic parameter vector i) can generate random numbers for discrete times of the one time-dependent uncertainty parameter of the at least one component of the stochastic parameter vector within a predefined time interval according to a predefined distribution function, describing the stochastic process (e.g., drawn randomly at each time step or once at the beginning of the simulation), and ii) can comprise averaging the generated random numbers. Moreover, each sampling of the static parameter vector may comprise generating a random number for the static uncertainty parameter of the at least one component of the static parameter vector according to a predefined statistical distribution for the uncertainty parameter. In addition, each sampling of the random vector may comprise generating the one or more random numbers for the one or more random static variables of the random vector according to a predefined statistical distribution for the one or more random static variables of the random vector. The samples for the other components of the vectors discussed above, if any, may be generated in the same manner.

In the case of the present techniques, the one or more expected values E(zₖ) and the one or more variances V(zₖ) of the one or more state variables of the state vector zₖ may be calculated using the number of samples (i.e., directly without any further simplification as discussed further below). Moreover, the one or more expected values E(uₖ) and the one or more variances V(uₖ) of the one or more input variables of the input vector uₖ may be calculated using the number of samples. In one example, these calculations may be performed based on a Monte-Carlo simulation or Latin Hypercube sampling method. It should be noted that the “decomposition 200” and “approximation 300” method steps discussed above already make a significant contribution to reducing the computational time of the optimization problem (despite subsequent application of the Monte-Carlo simulation or a Latin hypercube sampling method). In one example, the expected values E(zₖ) and variances V(zₖ) of the one or more state variables of the state vector zₖ for N samples (i=1, . . . , N) may be given by the following expression:

$$E ( {z}_{k} ) = \frac{1}{N} {\sum }_{i = I}^{N} {z}_{k}^{( i )} , V ( {z}_{k} ) = \frac{1}{N - 1} {\sum }_{i = 1}^{N} {[ {z}_{k}^{( i )} - E ( {z}_{k} ) ]}^{2} .$$

Likewise, the expected values E(uₖ) and the variances V(uₖ) of the one or more input variables of the input vector uₖ for the N samples (i=1, . . . , N) in this example may be given by the following expression:

$$E ( {u}_{k} ) = \frac{1}{N} {\sum }_{i = 1}^{N} {u}_{k}^{( i )} , V ( {u}_{k} ) = \frac{1}{N - 1} {\sum }_{i = 1}^{N} {[ {u}_{k}^{( i )} - E ( {u}_{k} ) ]}^{2} .$$

Furthermore, the techniques of the present disclosure may comprise determining 400 a surrogate model of the discrete-time representation of the dynamic model using the approximated predefined function. Determining the surrogate model may include establishing 400 one or more polynomial base functions that are functions of an uncertainty vector. The uncertainty vector may comprise the following vectors: i) the static parameter vector, ii) the random vector, and iii) a mean stochastic parameter vector averaged within a predefined time interval. In examples, the uncertainty vector may be written as follows (also in accordance with the above discussions): θ=[p^{T}, ζ^{T}, w̅^{T}]^{T}. In some cases, establishing the one or more polynomial base functions may be based on the respective statistical distributions (see also above discussions) for these vectors. For example, establishing the one or more polynomial base functions may be based on the number of samples i) for the static parameter vector, ii) for the random vector, and iii) for the mean stochastic parameter vector (see discussions above).

Furthermore, determining the surrogate model may include performing 420 a series expansion of the state vector into a series of the one or more polynomial base functions, wherein one or more respective expansion coefficients of the series expansion are independent of the uncertainty vector. In one example, the one or more polynomial base functions may be at least one of Hermite polynomials, Legendre polynomials, Jacobi polynomials, and/or generalized Laguerre polynomials. In one example, the series expansion of the state vector may be expressed as follows:

$${z}_{k} ( θ ) = {\sum }_{n = 1}^{N} {Z}_{k , n} {ϕ}_{n} ( θ ) = {Z}_{k}^{T} ϕ ( θ ) .$$

Here, φₙ(θ) are polynomial base functions (total N in this example) and

$${Z}_{k}^{T}$$

are the corresponding expansion coefficients. In one example, the variable N may be predefined. For example, a larger N may result in a more accurate approximation but may necessitate a longer computational time and a smaller N may result in a more inaccurate approximation but may allow for shorter computational time.

In some cases, determining the surrogate model may occur using polynomial chaos development.

Moreover, the “determining 400 the surrogate model” method step may comprise projecting 440 the approximated predefined function onto the one or more polynomial base functions. The projecting 400 may be carried out by projecting the approximated predefined function by integrating the approximated predefined function multiplied by respective functions comprising the polynomial base functions, wherein the integration is performed in a space of the uncertainty vector and thereby a number of projection integrals are formed. In some cases, the surrogate model may comprise a plurality of matrices after projecting the approximated predefined function, wherein each matrix of the plurality of matrices comprises one or more projection integrals. In one example, the projected approximated predefined function may comprise one or more products of the one or more respective matrices of the plurality of matrices having the corresponding expansion coefficients of the series expansion. For example, the projected approximated predefined function may be equal to the product if only one product is present, or a sum of products if more than one product is present.

Using the present techniques, after determining 400 the surrogate model, it may no longer be required to perform sampling to solve the optimization problem so that one simulation may be sufficient, which may represent a further significant increase in efficiency versus a large number of simulations using UQ methods.

In one example, the determination of the surrogate model may be:

$${Z}_{k + 1} = {\underbrace{[ {\overline{A}}_{PCE} + T ( {g}_{k} ) {\tilde{A}}_{PCE} ]}}_{{A}_{PCE} ( {g}_{k} )} {Z}_{k} + {\underbrace{[ {\overline{B}}_{PCE} + T ( {g}_{k} ) {\tilde{B}}_{PCE} ]}}_{{B}_{PCE} ( {g}_{k} )} {U}_{k} + {E}_{PCE} {g}_{k} , {Z}_{0} = {Z}_{i n i}$$

$${U}_{k} = {K}_{PCE} {Z}_{k} , E ( {z}_{k} ) = {M}_{z} {Z}_{k} , V ( {z}_{k} ) = {V}_{z} {Z}_{k}^{2} , E ( {u}_{k} ) = {M}_{u} {K}_{PCE} {Z}_{k} ,$$

$$V ( {u}_{k} ) = {{V}_{u} ( {K}_{PCE} {Z}_{k} )}^{2} .$$

In that case, the projection integrals may be written as follows:

$${\overline{A}}_{PCE} = {F}^{- 1} {\int }_{Ω} ϕ ( θ ) \overline{A} ( θ ) {ϕ}^{T} ( θ ) d ω ( \text{?}$$

$${\tilde{A}}_{PCE} = {\int }_{Ω} ϕ ( θ ) \tilde{A} ( θ ) {ϕ}^{T} ( θ ) d ω ( \text{?}$$

$${Z}_{ini} = {F}^{- 1} {\int }_{Ω} ϕ ( ζ ) {z}_{ini} ( θ ) d ω ( \text{?}$$

$${\overline{B}}_{PCE} = {F}^{- 1} {\int }_{Ω} ϕ ( θ ) \overline{B} ( θ ) {ϕ}^{T} ( θ ) d ω ( \text{?}$$

$${\tilde{B}}_{PCE} = {\int }_{Ω} ϕ ( θ ) \tilde{B} ( θ ) {ϕ}^{T} ( θ ) d ω ( \text{?}$$

$${E}_{PCE} = {F}^{- 1} {\int }_{Ω} ϕ ( ζ ) E ( θ ) d ω ( θ )$$

$$\text{?} \text{indicates text missing or illegible when filed}$$

with

$$F = {\int }_{Ω} ϕ ( θ ) {ϕ}^{T} ( θ ) d ω ( θ ) , T ( {g}_{k} ) = {F}^{- 1} ( {g}_{k}^{T} ⊗ I ) .$$

Here, Ω is an area of the common probability density function (PDF) of the uncertainty vector θ. A differential may be provided by the expression dω(θ)=ρ(θ)dθ. The following expressions can apply to this: M_{z}=∫_{Ω}φ(ζ)dω(θ) and

$${V}_{z} = F - {M}_{z} {M}_{z}^{T} .$$

In some (deterministic) cases, the following may also apply: K_{PCE}(K)=(KC⊗I_{N}). In this case, the optimization problem can be written as follows:

$${min}_{K} J = {J}_{E} ( {M}_{z} Z , {M}_{u} {K}_{PCE} Z ) + {J}_{V} ( {V}_{z} {Z}^{\text{.2}} , {{V}_{u} ( {K}_{PCE} Z )}^{\text{.2}} )$$

$$s . t . {Z}_{k + 1} = [ {A}_{PCE} ( {g}_{k} ) + {B}_{PCE} ( {g}_{k} ) {K}_{PCE} ( K ) ] {Z}_{k} + {E}_{PCE} {g}_{k} k ∈ \{ 0 , … {k}_{f} \} ,$$

$${Z}_{0} = {Z}_{i n i} , K ∈ 𝕂 .$$

For further details on surrogate models, see, for example, the patent application “Computer-implemented method for determining a surrogate model of a state-space model”, DPMA file number: 102023206821.4.

In the following sections, the advantages of the techniques of the present disclosure over the prior art will be explained by way of FIG. 3a to FIG. 3c. In these figures, the results of returning a moving car to a traffic lane are shown with a straight-line driving maneuver. In this non-limiting example, the state vector zₖ=[\dot{ψ}ₖ, eₖ, βₖ] is comprised of three components, namely a yaw rate, \dot{ψ}ₖ, a lateral error, eₖ, and a side slip angle, βₖ, while the input vector uₖ=[δₖ] contains the steering angle, δₖ, as a single component (the index k denotes a time point as defined above). In the process, a time-variant external wind force W is considered to be a time-dependent uncertainty parameter, but due to its construction, it provides a substantially linear contribution to the predefined function and can thus be considered a contribution to the approximated predefined function (the non-linearity regarding wₖ is lacking). Some typical dependencies, W, 60 of time t, are shown in FIG. 3a. In this example, the road friction, the location of the vehicle center of gravity, and an uncertain static feedback delay (e.g., the network delay within the E/E architecture of the vehicle) also play a role and are considered static uncertainty parameters that form a static parameter vector p of the present techniques. In FIGS. 3b and 3c, the side slip angle, βₖ, and the side error, eₖ, are shown as a function of time t: Specifically, the expected values of βₖ and eₖ (curves 20, 21) with the respective variances (ranges 40, 41) resulting from application of stochastic optimization according to the method of the present disclosure and the expected values of βₖ and eₖ (curves 30, 31) with the respective variances (ranges 50, 51) obtained by application of a Monte-Carlo simulation (prior art) are shown. In both optimization methods, the trajectories for the expected values of βₖ and eₖ approximate the predefined values (zero in this example), however, the stochastic optimization of the present techniques shows a much faster approximation of the predefined values without high amplitude oscillations around these values: This may, for example, minimize a driving safety risk, particularly with a greater number of vehicles and slippery road conditions.

A second general aspect of the present disclosure concerns a computer program adapted to perform the computer-implemented method of designing a state controller with stochastic optimization according to the first general aspect. The computer program may, for example, be present in interpretable or compiled form. For execution, it may be loaded (also in portions) into the RAM of a computer, for example, as a bit or byte sequence.

A third general aspect of the present disclosure concerns a computer system adapted to perform the computer-implemented method of designing a state controller with stochastic optimization according to the first aspect and/or the computer program according to the second aspect. The computer system may include at least one processor, at least one memory (which may include programs that, when executed, perform the methods of the present disclosure) and at least one interface for inputs and outputs. The computer system may be a “stand-alone” system or a distributed system that communicates over a network (e.g., the Internet).

A fourth general aspect of the present disclosure relates to a computer readable medium (e.g., a machine readable storage medium such as, for example, an optical storage medium or memory, e.g., FLASH memory) or signal that stores and/or contains the computer program according to the second general aspect.
A fifth general aspect of the present disclosure relates to a state controller adapted to control a system, in particular one that is part of an autonomous and/or automated driving system, wherein the state controller has been optimized according to the computer-implemented method of designing a state controller with stochastic optimization according to the first aspect. In some cases, this may mean that the fifth aspect state controller is described by the feedback matrix K determined after solving the optimization problem of the first aspect. For example, the fifth aspect state controller may include or be part of a hardware module having inputs and outputs. In the examples, a state controller may be a controller, a part of the controller, or the controller itself.

What is claimed is:

1. A computer-implemented method for designing a state controller with stochastic optimization, comprising:
receiving a dynamic model for describing a system to be controlled, wherein the dynamic model is represented by a predefined function (f(zₖ, p, wₖ, uₖ)), wherein the predefined function includes the following time-dependent arguments:
a state vector (zₖ) comprising one or more state variables;
an input vector (uₖ) comprising one or more input variables and connected to the state vector (zₖ) by a feedback matrix (K) describing the state controller, and
a stochastic parameter vector (wₖ) having at least one component comprising a time-dependent uncertainty parameter describing a stochastic process, wherein the predefined function has a non-linear dependence with respect to the stochastic parameter vector and further includes a time-independent argument given by a static parameter vector (p) with at least one component comprising a static uncertainty parameter;
forming a discrete-time representation of the dynamic model for describing the system to be controlled by a time discretization of the predefined function;
decomposing the stochastic parameter vector (wₖ) into one or more deterministic modes (g_{j,k}), wherein each mode is associated with a respective eigenvalue (λⱼ), wherein the decomposed stochastic parameter vector (wₖ) is determined based on a random vector comprising one or more random variables (ζⱼ) as components;
approximating the predefined function to resolve the non-linear dependence with respect to the stochastic parameter vector (wₖ); and
solving an optimization problem to determine the component of the feedback matrix (K),
wherein the optimization problem comprises a cost function (J) calculated based on one or more expected values (E(zₖ); E(uₖ)) and one or more variances (V(zₖ); V(uₖ)) of the one or more state variables of the state vector (zₖ) and/or the one or more input variables of the input vector (uₖ).

2. The method according to claim 1, wherein decomposition of the stochastic parameter vector (wₖ) into the one or more deterministic modes (g_{j,k}) comprises:
receiving a predefined correlation function (C(t, t′)) quantifying a temporal correlation of the stochastic process between a first time point (tₖ) and a second time point (tₗ) that are different from one another and lie within a predefined time interval (T); and
solving an eigenvalue problem using the predefined correlation function to determine one or more eigenvalues (λⱼ) and the one or more deterministic modes (g_{j,k}).

3. The method according to claim 1, wherein decomposing the stochastic parameter vector into the one or more deterministic modes further comprises:
calculating the one or more random static variables (ζⱼ) of the random vector distributed according to a predefined statistical distribution;
calculating a sum consisting of one or more terms, wherein each term of said sum is a product of a deterministic mode and a factor calculated based on the eigenvalue to which said deterministic mode belongs and a respective random variable of the random vector; and
determining the decomposed stochastic parameter vector based on the calculated sum.

4. The method according to claim 1, wherein a number (J) of the one or more deterministic modes (g_{j,k}) is selected such that the decomposed stochastic parameter vector (wₖ) satisfies a predefined criterion.

5. The method according to claim 1, wherein approximating the predefined function (f(zₖ, p, wₖ, uₖ)) further comprises:
determining a first contribution calculated by calculating the predefined function for a mean stochastic parameter vector (w̅), wherein the mean stochastic parameter vector is averaged within a predefined time interval;
determining a second contribution comprising the decomposed stochastic parameter vector and a function associated with the predefined function calculated for the mean stochastic parameter vector (w̅); and
approximating the predefined function (f(zₖ, p, wₖ, uₖ)) based on the first and second contributions.

6. The method according to claim 5, wherein the function associated with the predefined function is based on one of the following functions:
a Jacobian matrix of the predefined function calculated in the mean stochastic parameter vector, if the predefined function is a differentiable function with respect to the stochastic parameter vector,
a difference quotient with respect to the predefined function calculated in the mean stochastic parameter vector as an expansion point, if the predefined function is not a function that is differentiable with respect to the stochastic parameter vector, and
wherein a distance used in the difference quotient is selected based on a variance of the stochastic process.

7. The method according to claim 1, wherein:
the approximated function with respect to the decomposed stochastic parameter vector assumes a multiplicative and/or additive form with respect to the stochastic parameter vector,
the multiplicative form with respect to the stochastic parameter vector means that this approximated function comprises one or more multiplicative terms that are proportional to the product of the state vector and the one or more deterministic modes and/or the input vector and the one or more deterministic modes, and
the additive form with respect to the stochastic parameter vector means that this approximated function comprises one or more additive terms that are proportional to the one or more deterministic modes.

8. The method according to claim 1, wherein solving the optimization problem further comprises:
determining the one or more expected values and the one or more variances of the one or more state variables of the state vector (zₖ) and/or the one or more input variables of the input vector (uₖ),
wherein the cost function J is formed by an expected value contribution and a variance contribution,
wherein the expected value contribution is formed by a first contribution corresponding to the one or more expected values of the one or more state variables of the state vector (zₖ) and/or by a second contribution corresponding to the one or more expected values of the one or more input variables of the input vector (uₖ), and
wherein the variance contribution is formed by a third contribution corresponding to the one or more variances of the one or more state variables of the state vector (zₖ) and/or a fourth contribution corresponding to the one or more variances of the one or more input variables of the input vector (uₖ).

9. The method according to claim 1, wherein the optimization problem comprises minimizing the cost function J with respect to the components of the feedback matrix (K).

10. The method according to claim 1, wherein forming the discrete-time representation of the dynamic model for describing the system to be controlled further comprises generating a number of samples i) for the static parameter vector, ii) for the random vector, and iii) for a mean stochastic parameter vector averaged within a predefined time interval.

11. The method according to claim 1, further comprising determining a surrogate model of discrete-time representation of the dynamic model using the approximated predefined function, wherein the determination comprises:
establishing one or more polynomial base functions that are functions of an uncertainty vector,
wherein the uncertainty vector comprises the following vectors: i) the static parameter vector, ii) the random vector, and iii) a mean stochastic parameter vector averaged within a predefined time interval;
performing a series expansion of the state vector into a series of the one or more polynomial base functions, wherein one or more respective expansion coefficients of the series expansion are independent of the uncertainty vector; and
projecting the approximated predefined function onto the one or more polynomial base functions.

12. A computer program adapted to perform the computer-implemented method of designing a state controller with stochastic optimization according to claim 1.

13. The computer system adapted to perform the computer-implemented method of designing a stochastic optimization state controller according to claim 1.

14. The computer-readable medium or signal storing and/or containing the computer program according to claim 12.

15. A state controller adapted to control an autonomous and/or automated driving system, wherein the state controller has been optimized according to the computer-implemented method of designing a state controller with stochastic optimization according to claim 1.

16. The computer system adapted to perform the computer-implemented method of designing a stochastic optimization state controller according to the computer program according to claim 12.
